(19) United States
(12) Patent Application Publication
(10) Pub. No.: US 2020/0314736 A1
(43) Pub. Date: Oct. 1, 2020

(54) VEHICLE EVENT DATA RECORDING WITH SNAPSHOT OF WIRELESS ENVIRONMENT

(71) Applicant: FORD GLOBAL TECHNOLOGIES, LLC, DEARBORN, MI (US)

(72) Inventors: Brad A. Ignaczak, Canton, MI (US); Somak Datta Gupta, Novi, MI (US); Cynthia M. Neubecker, Westland, MI (US)

(21) Appl. No.: 16/367,447

(22) Filed: Mar. 28, 2019

(51) Int. Cl. H04W 48/16; H04W 24/10; H04W 4/80; H04W 4/44; H04W 4/46; H04W 8/00

(52) U.S. Cl. CPC H04W 48/16; H04W 24/10; H04W 8/005; H04W 4/44; H04W 4/46; H04W 4/80

(57) ABSTRACT

Event data recording for a road vehicle to support event reconstruction after a trigger event includes a snapshot of the wireless environment within which the vehicle resides. Radio frequency (RF) signals are received from external sources in a vicinity of the vehicle via a plurality of antennas connected to a plurality of receivers. Wireless metadata is compiled based on the detected RF signals. The compiled metadata is timestamped, and then the timestamped metadata is queued in a buffer memory. A trigger event is detected indicating occurrence of an event for subsequent reconstruction. Respective metadata is transferred from the buffer memory to a non-volatile memory upon occurrence of the trigger event. The wireless metadata may preferably include identifiers or signal strength of WiFi or Bluetooth devices, active cellular telephone channels, detected DSRC messages, and spectrum data of EMI sources.

### CROSS REFERENCE TO RELATED APPLICATIONS

Not Applicable.

### STATEMENT REGARDING FEDERALLY SPONSORED RESEARCH

Not Applicable.

### BACKGROUND OF THE INVENTION

The present invention relates in general to event data recording in road vehicles for accident or other event reconstruction, and, more specifically, to monitoring a wireless environment for inclusion with recorded video as part of the recorded event data.

Event data recording systems have been deployed in some vehicles in order to preserve information about the vehicle and its surroundings around the time of a significant event, such as a collision. One type of system is a “Dash Camera” system which captures video information about the environment either continuously or beginning with the detection of a trigger event. Known systems have typically included a single forward-looking camera or multiple cameras in order to provide multiple views or even a full 360° view. However, these systems have limitations due to inherent properties of the cameras (e.g., limited field of view or range, resolution, light sensitivity, frame rate, etc.) and of the environment (light blockage, weather, etc.). In certain cases, every possible scrap of information could play an important role in ascertaining the causes of an event. The captured images might not provide a whole picture of the influences upon, participants in, or witnesses to an event. Furthermore, the captured images may provide insufficient details to reliably identify a vehicle or person fleeing an event.

### SUMMARY OF THE INVENTION

In preferred embodiments of the invention, a vehicle imaging system is augmented to capture information about the wireless activities within range of the vehicle, and the captured wireless information is stored in a memory (e.g., in the vehicle or sent wirelessly from the vehicle to a remote location such as cloud storage) at or near the time of an event in order to be preserved for later reconstruction of the event. Metadata relating to various types of wireless information can be utilized.

In one example, WiFi transmissions in 2.4 GHz and 5 GHz frequency bands can be passively monitored. The WiFi signals may be emitted from a smart phone or other portable device to a wireless router (e.g., in a unit located near a roadway or in a vehicle). The metadata being logged can include the SSID, MAC address, and a measured signal strength from each WiFi access point or WiFi device nearby. To provide a thorough snapshot of the wireless environment, all potential WiFi channels can be scanned. Reception via multiple WiFi antennas on the vehicle can be used in order to triangulate the position of the device based on relative signal strengths at the different antennas.

In another example, active monitoring is performed for nearby Bluetooth devices (e.g., cellphones and wearable devices) by sending a presence request. For detected devices, the signal strength is logged and the metadata may provide a list of devices with the signal strengths. Again, multiple WiFi antennas can be deployed on the vehicle to triangulate the position of the device. Bluetooth emissions can also be passively monitored.

The wireless environment to be monitored can also include RF signals using the Dedicated Short Range Communications (DSRC) protocol within an Intelligent Transportation System (ITS). The monitored signals may include vehicle-to-vehicle (V2V) or vehicle-to-infrastructure (V2I) messages, wherein the stored metadata can include contents of such messages (e.g., location, vehicle states, and traffic signals) as well as RF signal strength and the number/identity of sources.

In another example, transmissions from nearby cellphones or other portable devices to a cell tower are monitored. Triangulation of location can be supported by recording the signal strengths for each particular device at the multiple antennas.

Other example devices include drones or drone remote controllers (for both data and control signals) and wireless security cameras which often transmit in 2.4 GHz, 5 GHz, or 5.8 GHz bands.

For the above examples of established radio services using licensed or unlicensed RF access, the vehicle may preferably include an appropriate receiver adapted to detect the corresponding RF signals. Other aspects of the RF environment can also be monitored such as electromagnetic interference (EMI) from nearby unintentional emitters (e.g., microwave ovens or electric motors) or intentional transmitters using an RF service for which a dedicated receiver is not present (e.g., aircraft). The EMI can be received using a wideband receiver and the signal characterized using a spectrum analyzer, for example.

In one aspect of the invention, vehicular apparatus comprises a plurality of wireless receivers detecting respective radio frequency (RF) signals from external sources. As used herein, “external source” includes portable devices (i.e., sources not fixed to the vehicle) carried by persons either inside or outside the vehicle. A central controller compiles wireless metadata based on the detected RF signals. A buffer memory is provided for queueing newly compiled metadata together with respective timestamps identifying times of collection of the metadata. A non-volatile memory provides for longer term storage of respective metadata from the buffer memory upon occurrence of a trigger event. The wireless metadata may preferably include network identifiers of active WiFi devices, active cellular telephone channels, contents or source identifiers of detected DSRC messages (i.e., V2V or V2I communications), spectrum data of detected EMI sources, and a listing of available Bluetooth devices. The compiled metadata may preferably include a measured signal strength for an RF signal detected by a receiver.

### BRIEF DESCRIPTION OF THE DRAWINGS

FIG. 1 is a top view of a host vehicle moving on a roadway with a dash camera system capturing forward-looking video images.

FIG. 2 is a top view of a host vehicle moving on a roadway with an event data recording system augmented to record information about a wireless environment resulting from RF sources around the vehicle.

FIG. 3 is a flowchart showing one preferred method of the invention.

FIG. 4 is a block diagram showing a vehicle apparatus according to one embodiment of the invention.

FIG. 5 is a block diagram showing a portion of the vehicle apparatus of FIG. 4 in greater detail.

### DETAILED DESCRIPTION OF PREFERRED EMBODIMENTS

Augmenting an event data recording system to monitor and preserve metadata relating to a wireless RF environment provides significant new advantages in event reconstruction, law enforcement, and personal security. For event reconstruction, wireless information logged near the time of the incident can be used to reconstruct various details, including estimating the number of occupants in a vehicle, identifying the vehicle occupants based on detected devices, or estimating the number of pedestrians or other vehicles that were near the incident. In connection with a hit and run event, the captured wireless environment information obtained before the offending vehicle drives away can include wireless signatures that can be analyzed along with the video data to help identify the vehicle. The preserved metadata can be used by law enforcement to detect wireless signals and isolate certain signatures in the data to match against various databases. In regard to personal security, a user can review the wireless environment to check whether anyone carrying a portable wireless device is located near the vehicle before exiting the vehicle in a remote area, for example.

Many vehicles would already be provided with sensors (i.e., receivers) that detect a variety of wireless signals (e.g., WiFi, Bluetooth, BLE, and Cellular). Additional receivers can be added to cover additional bands or to enhance detection performance. During times that the vehicle is operating normally, each of the receivers will monitor their corresponding wireless signals and store relevant metadata information (e.g., device IDs, signal strength, and location) into a memory buffer such as a ring buffer with a capacity to store all the metadata collected for at least a desired duration (e.g., 30 seconds, 60 seconds, or 90 seconds). The ring buffer size preferably configured to be sufficient to hold twice the data or more that is collected during a desired snapshot duration, in order to ensure definite availability of snapshot data of the configured duration whenever an event occurs. The central module ring buffer preferably stores the metadata from all the receivers with respective timestamps without any data loss. For example, if one receiver/sensor reports samples every 100 ms and another every 1 ms, each of them will be stored at their native frequency.

Preferably, the vehicle uses several different onboard antennas working at different respective frequency bands to produce a robust wireless map of the vehicle wireless surroundings. Known types of receivers or transceivers are used to detect, demodulate, and/or evaluate RF signals for various known radio services (e.g., WiFi, Bluetooth, DSRC, and cellular). For unintentional radiators or transmitters for other radio services, an on-chip spectrum analyzer can be used to detect and quantify electromagnetic interference, e.g., in the 2.4 GHz, 5.8 GHz, and 5.9 GHz bands. A known type of WiFi chip can be dual used for this purpose.

When a trigger event (e.g., an acceleration or deceleration event, or a user-triggered event button) is detected, the RF metadata information from the vehicle receivers compiled by a central storage module (e.g., a Dash Camera module, a Body Control Module, or other module in vehicle) is transferred to a non-volatile memory which may be located in the vehicle or offboard. The receivers can alternatively send the wireless environmental data for compilation and long term storage after the trigger event occurs.

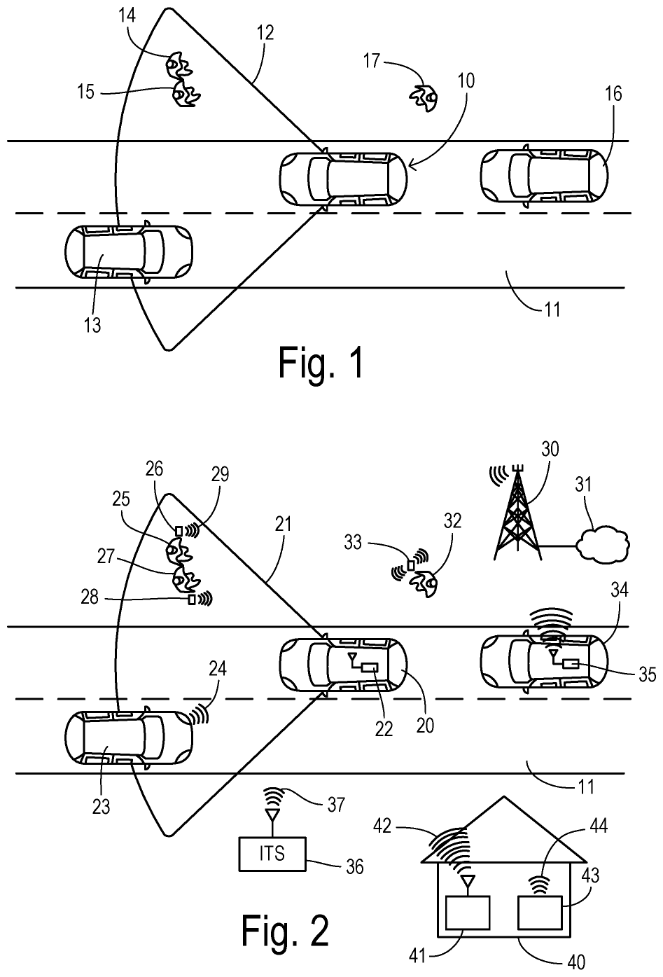

Referring to FIG. 1, a host vehicle 10 which is driving on a roadway 11 has a video recording system providing a field of view 12 via a forward-looking “dash cam” system, for example. A nearby vehicle 13 and pedestrians 14 and 15 are seen within the field of view 12, and video evidence of the presence of these objects would be preserved in the event of the triggering of a recording event. On the other hand, a vehicle 16 driving behind vehicle 10 and a pedestrian 17 would not be seen in the recorded video. Furthermore, the types information that have typically been discernible is limited to items that can be resolved by video images and has not included other potential sources of information outside the host vehicle. It would be desirable to provide a more comprehensive understanding of the environment at the time of an event without significantly increasing the hardware costs, particularly the cost of additional cameras or other sensors.

FIG. 2 shows an arrangement wherein wireless RF signal information is collected from the environment surrounding a host vehicle 20, using wireless receivers that would typically already be present within host vehicle 20 as it moves on roadway 11. Vehicle 20 may still include a dash cam system providing a field of view 21 for recording video information to be saved before and during an event. In addition, host vehicle 20 includes a plurality of receivers 22 with corresponding antennas to monitor and record a wireless environment near the vehicle. A nearby vehicle 23 (for which video is recorded since it appears within the video field of view 21) emits various types of RF signals 24 which may be monitored by host vehicle 20 as described below. Any types of RF signals can be monitored, including without limitation DSRC signals, cellular telephone signals, Bluetooth signals, tire pressure monitoring signals, and wireless signals from a vehicle security system. Another nearby vehicle 34 not within video field of view 21 likewise emits RF signals to the wireless environment via a transmitter 35 which can be monitored in the same fashion.

Also within field of view 21 are a pedestrian 25 having a portable wireless device 26 and a pedestrian 27 having a portable wireless device 28. Devices 26 and 28 may be comprised of smartphones, for example. RF signals 29 are emitted which can be comprised of cellular signals, Bluetooth signals, Wi-Fi signals, or any other form of wireless communication. In the case of cellular signals, devices 26 and 28 are in communication with a cellular tower 30 interconnected with a carrier network 31. Receivers 22 in host vehicle 20 can be configured to monitor cellular phone signals 29 from nearby devices 26 and 28 and/or cellular signals from tower 30. Not within field of view 21, a pedestrian 32 carries a portable wireless device 33. The corresponding RF signals of wireless device 33 may be monitored and detected as respective components in the wireless environment to be included in the recorded data for an event. In addition, portable devices (not shown) can be detected and monitored by host vehicle 20 which have been carried into the passenger compartment of vehicle 20 (i.e., they are external sources in the sense that they are not hard-wired to vehicle 20).

The invention can monitor other fixed sources within the wireless environment. For example, a roadside node 36 of an intelligent transportation system (ITS) is within the range of host vehicle 20 which transmits DSRC signals 37 as part of V2I communications. The DSRC signals which can be detected, demodulated, and compiled into the stored data for recording during a trigger event. The metadata compiled from DSRC signals in a preferred embodiment may include the number of sources and addresses or other identifiers of the sources. The metadata can further include detected and/or demodulated signals representing ITS information such as the state of traffic control signals (traffic lights), vehicle IDs, and vehicle location, heading, and speed.

Another fixed external source of RF signals may include a building 40 having an RF transmitter 41 such as a WiFi router which emits RF signals 42. Building 40 or other facilities may also include electrical equipment such as a device 43 (e.g., a motor) which unintentionally or passively radiates RF signals 44 as electromagnetic interference. Signals 44 contribute to the monitored wireless environment and can be recorded to indicate various types of activity that may be in progress during a trigger event.

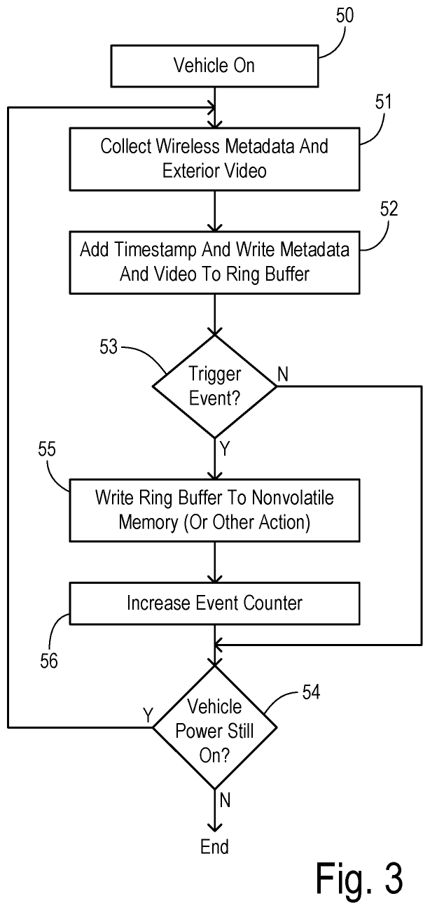

FIG. 3 shows a preferred method of the invention which is initiated when the vehicle is turned on at step 50. In step 51, wireless metadata and exterior video are collected according to the wireless and visual environment around the vehicle continuously during vehicle operation. As the wireless metadata and video are collected, a timestamp is added in step 52 and the metadata and video data are written (e.g., queued) to a ring buffer. A check is performed in step 53 to determine whether a trigger event has occurred, such as the occurrence of a sharp acceleration or a manual activation of a trigger button by a vehicle occupant. If there is no trigger event, then a check is performed in step 54 to determine whether vehicle power is still on. If power is still on then a return is made to step 51 for continuing to collect wireless metadata and exterior video. If power is off, then the method ends.

When a trigger event is detected in step 53, then the contents currently queued with the buffer memory are written in step 55 into a nonvolatile memory in the vehicle or some other location such as an offboard server in a cloud. The nonvolatile memory provides longer-term storage to facilitate accident reconstruction or other analysis after an event has occurred. In step 56, an event counter is increased so that a subsequent trigger event results in additional ring buffer data being written to a different portion of the nonvolatile memory.

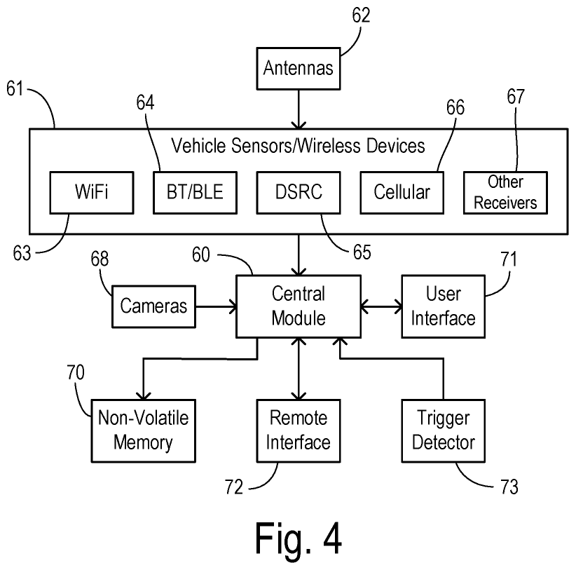

One preferred vehicle or apparatus of the invention as shown in FIG. 4 wherein a central module 60 coordinates the collection, compiling, time stamping, and storing of information characterizing the wireless environment. A plurality of vehicle sensors/wireless devices include a plurality of receivers 61 which are connected to corresponding antennas 62. Receivers 61 may include a WiFi receiver 63, Bluetooth node 64, DSRC receiver 65, cellular transceiver 66, and other receivers 67 (e.g., a wideband receiver or a tire pressure monitoring receiver). As central module 60 collects and compiles wireless metadata based on detected RF signals via antennas 62 and receivers 61, concurrent video signals are collected from cameras 68. A nonvolatile memory 70 is connected to central module 60 for receiving respective metadata from a buffer memory in central module 60 upon occurrence of a trigger event.

A user interface 71 is connected to central module 60 adapted for use in configuring the system and for providing local user access to the compiled and/or stored information from nonvolatile memory 70 and/or from the buffer memory. A remote interface 72 can be provided for sharing of recorded event data with third parties, e.g., wirelessly sharing to a call center or law enforcement. The vehicle apparatus includes a trigger detector 73 which may utilize a signal generated in a vehicle powertrain controller or safety restraints controller (not shown) or may include a user control button within user interface 71.

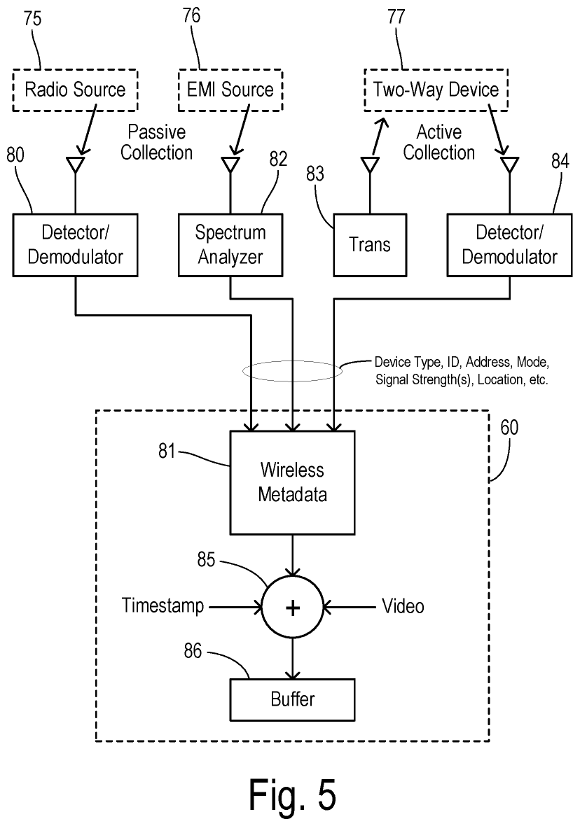

Data collection and compilation of wireless metadata is shown in greater detail in FIG. 5. External sources producing radiofrequency (RF) signals include one or more radio sources 75 which are broadcasting via a licensed or unlicensed radio service, one or more EMI sources 76, and one or more two-way radio devices 77 also operating via an established radio service. The invention may perform passive signal collection using a detector/demodulator 80 which is configured to respond to RF signals from a radio source 75. RF signal parameters and/or signal-based information is output by detector/demodulator 80 for compilation as wireless metadata 81 in central control module 60. The information may include a device type, device identifier, address, signal type or mode of operation, signal strength(s), and device location. Passive collection may further utilize a spectrum analyzer 82 as part of a wideband receiver for analyzing RF signals from EMI source 76 and providing wireless metadata 81 including a measured RF spectrum emitted by EMI source 76.

The invention may perform active collection of RF signals from external sources using an interrogating transmitter 83 to send presence requests or other interrogating signals to a two-way RF device 77, such as a Bluetooth transceiver. The presence request elicits the emission of responsive RF signals from two-way device 77 which are picked up by a detector/demodulator 84 which provides the same or similar types of wireless metadata 81 to be compiled within central control module 60.

Within central module 60, the compiled wireless metadata 81 is combined with timestamps and video signals in a combiner 85, and a resulting data stream is queued in a buffer memory 86. Preferably, buffer memory 86 is comprised of a ring buffer which queues newly compiled metadata according to a continuously updated data pointer so that the oldest metadata within buffer 86 is continuously overwritten by newly compiled metadata. Preferably, the full contents of ring buffer 86 are recorded as a snapshot by transferring to the nonvolatile memory whenever a trigger event occurs.

1. Vehicular apparatus in a road vehicle comprising:
a plurality of wireless receivers detecting respective radio frequency (RF) signals transmitted by external sources, wherein the plurality of wireless receivers includes a wideband receiver for monitoring wideband electromagnetic interference (EMI);
a central controller for compiling wireless metadata based on the detected RF signals to characterize an RF wireless environment around the vehicle, wherein the compiled metadata includes a spectrum of the monitored EMI;
a buffer memory for queueing newly compiled metadata together with respective timestamps identifying times of collection of the metadata; and
a non-volatile memory for longer term storage of respective metadata in the buffer memory upon occurrence of a trigger event.

2. The apparatus of claim 1 wherein the plurality of wireless receivers includes a WiFi receiver, and wherein the compiled metadata includes a network identifier of an external source.

3. The apparatus of claim 2 wherein the WiFi receiver scans a plurality of frequency channels for active WiFi devices.

4. The apparatus of claim 1 wherein the plurality of wireless receivers includes a cellular receiver, and wherein the compiled metadata includes identification of at least one cellular channel having active transmission.

5. The apparatus of claim 1 wherein the plurality of wireless receivers includes a DSRC receiver, and wherein the compiled metadata includes contents of a detected DSRC message and a source identifier.

6. (canceled)

7. The apparatus of claim 1 wherein the plurality of wireless receivers includes a Bluetooth transceiver, wherein the Bluetooth transceiver periodically sends a presence request, and wherein the compiled metadata includes a listing of detected Bluetooth devices.

8. The apparatus of claim 1 wherein the compiled metadata includes a measured signal strength for an RF signal detected by a receiver.

9. The apparatus of claim 1 wherein one of the receivers detects a respective RF signal via a plurality of antennas, and wherein the compiled metadata includes a respective measured signal strength of the respective RF signal derived from each respective antenna.

10. The apparatus of claim 1 wherein the compiled metadata includes a detected location of a respective source of RF signals.

11. The apparatus of claim 1 wherein the buffer memory is comprised of a ring buffer.

12. A method of data recording in a road vehicle, comprising the steps of:
receiving radio frequency (RF) signals transmitted by external sources in a vicinity of the vehicle via a plurality of antennas connected to a plurality of receivers wherein the plurality of wireless receivers includes a wideband receiver for monitoring wideband electromagnetic interference (EMI);
compiling wireless metadata based on the detected RF signals to characterize an RF wireless environment around the vehicle, wherein the compiled metadata includes a spectrum of the monitored EMI;
timestamping the compiled metadata;
queueing the timestamped metadata in a buffer memory;
detecting a trigger event indicating occurrence of an event for subsequent reconstruction; and
transferring respective metadata from the buffer memory to a non-volatile memory upon occurrence of the trigger event.

13. The method of claim 12 wherein the compiled metadata includes a measured signal strength for a respective RF signal detected by a receiver.

14. The method of claim 12 wherein a respective RF signal is detected via a plurality of antennas, and wherein the compiled metadata includes a respective measured signal strength of the respective RF signal derived from each respective antenna.

15. The method of claim 12 wherein the compiled metadata includes a detected location of a respective source of RF signals.

16. The method of claim 12 wherein the plurality of receivers includes a WiFi receiver, and wherein the compiled metadata includes a network identifier of an external source.

17. The method of claim 12 wherein the plurality of receivers includes a cellular receiver, and wherein the compiled metadata includes identification of at least one cellular channel having active transmission.

18. The method of claim 12 wherein the plurality of receivers includes a DSRC receiver, and wherein the compiled metadata includes contents of a detected DSRC message and a source identifier.

19. (canceled)

20. The method of claim 12 wherein the plurality of receivers includes a Bluetooth transceiver, wherein the Bluetooth transceiver periodically sends a presence request, and wherein the compiled metadata includes a listing of detected Bluetooth devices.
